(19) United States
(12) Patent Application Publication
(10) Pub. No.: US 2014/0108939 A1
(43) Pub. Date: Apr. 17, 2014

(54) METHOD AND APPARATUS FOR MANAGING ONLINE CONTENT COLLECTIONS USING A SINGLE PROGRAMMING TOOL

(71) Applicants: ANINDITA MAHAPATRA, Methen, MA (US); Eric James Gieseke, Lincoln, MA (US)

(72) Inventors: ANINDITA MAHAPATRA, Methen, MA (US); Eric James Gieseke, Lincoln, MA (US)

(73) Assignee: Nokia Corporation, Espoo (FI)

(21) Appl. No.: 13/651,991

(22) Filed: Oct. 15, 2012

(51) Int. Cl. G06F 3/01

(52) U.S. Cl. 715/738

(57) ABSTRACT

An approach is provided for mapping relevant and up-to-date online content to content collections using a single programming tool. The collection management platform determines one or more content items from one or more content catalogs. The collection management platform causes, at least in part, a mapping of the one or more content items to one or more collection objects. The collection management platform causes, at least in part, a presentation of the one or more collection objects in one or more content stores, one or more content store management systems, or a combination thereof.

### BACKGROUND

Service providers and device manufacturers (e.g., wireless, cellular, etc.) are continually challenged to deliver value and convenience to consumers by, for example, providing compelling network services. One area of interest has been the development of online content stores (e.g., an application store) that can enable users to intelligently and efficiently download and/or preview online services or content (e.g., applications, games, media, etc.). To increase the number of “hits” for suggested services or content, online service providers often need to suggest and/or promote relevant services (e.g., mobile applications). One traditional way to facilitate the discovery of relevant applications is to present applications of potential interest to users as content collections (e.g., a list or grouping of content organized by themes, topics, etc.). When developing relevant content collections, content store managers, for example, often take into account such factors as user interests (past experience), location, device capabilities, language or keyword, authorship (e.g. a developer) or operators (e.g., a mobile phone service provider), etc. However, the temporal nature of such factors and the exponential growth of online services and content (e.g., hundreds of thousands of available applications) requires considerable time and human intervention as well as different tools and expensive training, all of which can inhibit online content stores from promoting the most relevant and up-to-date content to users. Accordingly, service providers and device manufacturers face significant technical challenges in providing a service that enables the efficient and effective management of online services or content.

### SOME EXAMPLE EMBODIMENTS

Therefore, there is a need for an approach for mapping relevant and up-to-date online content to content collections using a single programming tool.

According to one embodiment, a method comprises determining one or more content items from one or more content catalogs. The method also comprises causing, at least in part, a mapping of the one or more content items to one or more collection objects. The method further comprises causing, at least in part, a presentation of the one or more collection objects in one or more content stores, a content store management system, or a combination.

According to another embodiment, an apparatus comprises at least one processor, and at least one memory including computer program code for one or more computer programs, the at least one memory and the computer program code configured to, with the at least one processor, cause, at least in part, the apparatus to determine one or more content items from one or more content catalogs. The apparatus also causes, at least in part, a mapping of the one or more content items to one or more collection objects. The apparatus further causes, at least in part, a presentation of the one or more collection objects in one or more content stores, a content store management system, or a combination.

According to another embodiment, a computer-readable storage medium carries one or more sequences of one or more instructions which, when executed by one or more processors, cause, at least in part, an apparatus to determine one or more content items from one or more content catalogs. The apparatus also causes, at least in part, a mapping of the one or more content items to one or more collection objects. The apparatus further causes, at least in part, a presentation of the one or more collection objects in one or more content stores, a content store management system, or a combination.

According to another embodiment, an apparatus comprises means for determining one or more content items from one or more content catalogs. The apparatus also comprises means for causing, at least in part, a mapping of the one or more content items to one or more collection objects. The apparatus further comprises means for causing, at least in part, a presentation of the one or more collection objects in one or more content stores, a content store management system, or a combination.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side (e.g., via the computer system of FIG. 8) or on the mobile device side (e.g., via the mobile device of FIG. 10) or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of mapping relevant and up-to-date online content to content collections using a single programming tool, according to one embodiment;

FIG. 2A is a diagram of the components of a collection management platform, according to one embodiment;

FIG. 2B is a diagram of a collection object model employed by the collection management platform, according to one embodiment;

FIGS. 3A and 3B are diagrams of a collection object hierarchy for a single operator with different sub-collections for different user devices, according to one embodiment;

FIGS. 4 and 5 are flowcharts of processes for mapping relevant and up-to-date online content to content collections using a single programming tool, according to one embodiment;

FIG. 6 is a diagram of a user interface for defining one or more dynamic rules, according to one embodiment;

FIG. 7 is a diagram of a user interface for organizing one or more collection objects in one or more content stores, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile device that can be used to implement an embodiment of the invention.

### DESCRIPTION OF SOME EMBODIMENTS

Examples of a method, apparatus, and computer program for mapping relevant and up-to-date online content to content collections using a single programming tool are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

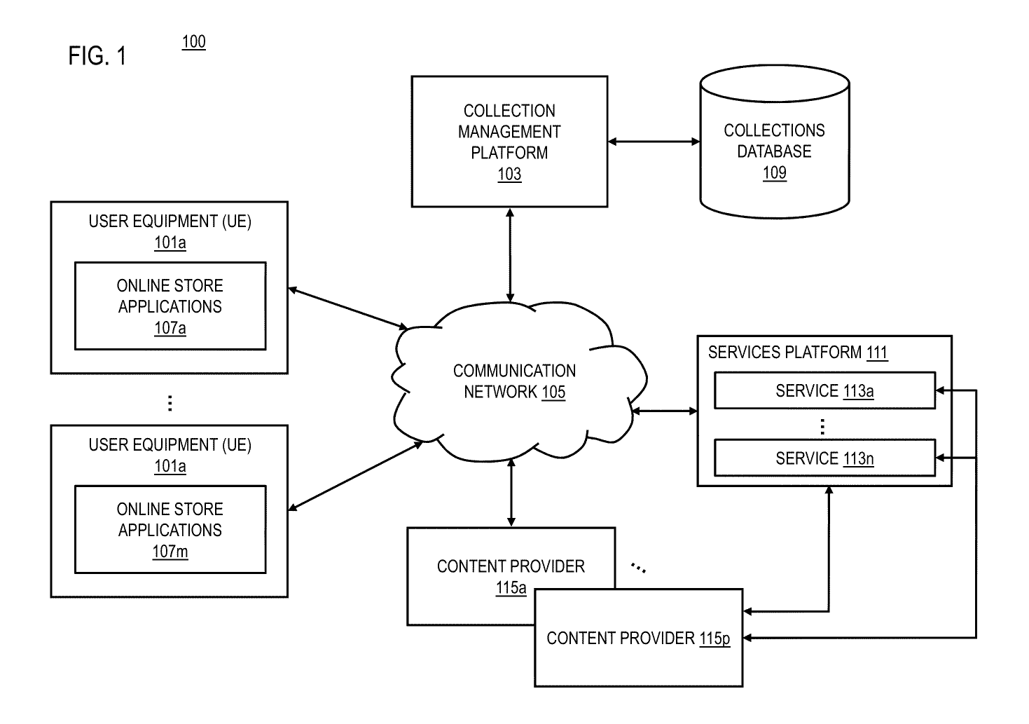

FIG. 1 is a diagram of a system capable of mapping relevant and up-to-date online content to content collections using a single programming tool, according to one embodiment. As previously discussed, one area of interest among service providers and device manufacturers has been the development of online content stores (e.g., an application store) that can enable users to intelligently and efficiently download and/or preview online services or content (e.g., applications, games, media, etc.). To increase the number of “hits” for suggested services or content, online service providers often need to suggest and/or promote relevant services (e.g., mobile applications). One traditional way to facilitate discovery of relevant applications is to present applications of potential interest to users as content collections (e.g., a list or grouping of content organized by themes, topics, etc.). When developing relevant content collections, content store managers, for example, may take into account such factors as user interests (past experience), location, device capabilities, language or keyword, authorship (e.g., a developer) and/or operators (e.g., a mobile phone service provider), etc. However, the temporal nature of such factors and the exponential growth of online services and content (e.g., hundreds of thousands of available applications) require considerable time and human intervention as well as different tools and expensive training, all of which can inhibit online content stores from promoting the most relevant and up-to-date content to users. In particular, the use of different tools among various global and local store managers, for example, impedes effective collaboration and communication among the managers (e.g., what works and what does not work). Also, current strategies generally employ “heavy” and/or complicated user interfaces that often require frequent and expensive client upgrades, which can further reduce the overall user experience.

To address this problem, a system 100 of FIG. 1 introduces the capability of mapping relevant and up-to-date online content to content collections using a single programming tool. In one embodiment, the system 100 first determines one or more content items from one or more content catalogs. More specifically, the system 100 can import data associated with the one or more content catalogs and all of its accessory objects from one or more authors and/or operators using a content store management system, for example. Moreover, although each of the one or more content catalogs may have their own format, it is contemplated that the system 100 can map the data into a common internal format for use by all of the components of the system 100. The one or more content items, for instance, include online services or content such as mobile applications (e.g., a puzzle videogame, a soccer application, a gardening application, etc.) that are designed to run on a user device such as a mobile device (e.g., a mobile phone or tablet). In addition, the one or more content items may contain several content variants (e.g., a free version, a paid version, etc.) By way of example, the system 100 can determine the one or more imported content items based, at least in part, on one or more static rules, one or more dynamic rules, or a combination thereof.

In one embodiment, the system 100 next determines one or more static rules, one or more dynamic rules, or a combination thereof associated with the one or more content items, one or more collection objects, or a combination thereof based, at least in part, on one or more parameters. In particular, the rules are specified or applied at a global, country, or regional (local) level (e.g., filtering content items based, at least in part, on one or more criteria), or a combination thereof. In addition, the rules specify one or more filters or executions for defining the means of content selection and programming. More specifically, the one or more static rules pertain to explicitly defined content (i.e., content or applications known in advance). In contrast, the one or more dynamic rules are based, at least in part, on one or more specified filter criteria (e.g., one or more parameters) and/or a sort order. As previously discussed, the one or more parameters may be based, at least in part, on location (e.g., a content store accessible in North America versus a content store accessible in the Middle East), device capabilities (e.g., processing power, display size, etc.), language or keywords, authorship (e.g., a developer) or operators (e.g., a mobile phone service provider), or a combination thereof. In addition, in one example use case, the filter criteria may also be based, at least in part, on a content category (e.g., “lifestyle,” “news and weather,” “travel,” etc.), a price point (e.g., “free,” “paid,” etc.), a publisher, a billing method (e.g., “credit card only”), an item sort order (e.g., “most recent”), a feed type (e.g., “user recommendation”), etc. Further, the system 100 includes one or more preview rules to enable content store managers, for example, to see the one or more content items associated with a particular rule before the system 100 generates the corresponding one or more collection objects. For example, a content store manager can preview the one or more parameters set for a rule (e.g., a country, a language, a device, etc.), view the one or more collection objects that refer to that rule, and preview the top 30 content items, for example, that will surface based on that rule. In addition, the system 100 can save the one or more dynamic rules in a database, for example, for compiling future one or more collection objects. Consequently, dynamic rule setting for content management reduces human intervention and ensures that there are no gaps in provisioning the one or more content items across all countries, devices, languages, operators, etc. (i.e., the same rule generates different content in different regions, on different devices, etc.), depending on the availability of the one or more content items in that milieu.

In one or more embodiments, the system 100 then causes, at least in part, a generation of one or more collection objects based, at least in part, on the one or more static rules, the one or more dynamic rules, or a combination thereof. Traditionally, users have been conditioned to think of individual content items (e.g., an application) when thinking of a content store (e.g., an application store). However, finding the relevant content item among several thousands (even hundreds of thousands in some instances) is a daunting challenge, especially to a user who is just browsing the store and is not fully engaged in the process. Therefore, it is contemplated that categorizing the one or more content items as one or more collection objects improves content discovery within a content store.

By way of example, one or more collection objects may include, for example, any grouping of one or more content items or any grouping of one or more sub-collection objects sharing one or more common attributes. More specifically, in one embodiment, the system 100 can consider everything in a content store (e.g., an application store) as one or more collection objects. Moreover, the system 100 can assign each of the one or more collection objects a name/description or id that can be localized in different languages for different markets/regions. The one or more collection objects may be static (i.e., explicitly defined) or dynamic (i.e., determined at runtime based on a rule). In addition, the one or more collection objects may be of several types, for example, a Standard Collection, which is an aggregation of one or more editorial items (e.g., a holiday collection, a travel collection, etc.); an Operator Collection (e.g., operator promoted content items); a Theme Pack Collection (e.g., promotional content items such as premium content offered at a discount); a Banner and Spotlight Collection (e.g., content items prominently displayed on the home page or a landing page of a content store); etc. In one or more embodiments, the system 100 may also consider the home page as a collection object (e.g., “featured content”), category pages as a collection object (e.g., “utilities,” “top free,” etc.), blacklist (e.g., prohibited content) or whitelist (e.g., promoted content) items as respective collection objects, etc. Further, the system 100 may use one or more collection objects as building blocks for one or more other collection objects. For example, the system 100 can construct a collection object that is an amalgamation of a price point collection, an entertainment collection, and a sorted by “most recent” collection. Also, the system 100 enables a store content manager, for example, to input an id, a sub-type, a keyword, a tag, etc. into a content store management system, for example, to provide better internal organization and classification to help promote more efficient searches in the future. Additionally, the one or more collection objects may be assigned a start/end date so that they may be used by a content store manager, for example, for timely promotion.

By way of further example, the system 100 can ensure that a newly published application related to soccer automatically gets added to a dynamic soccer collection based, at least in part, on the keyword “soccer.” Similarly, the system 100 can ensure that a newly published application by a well-known developer (e.g., a puzzle application) gets added to a dynamic puzzle collection. Consequently, it is contemplated that the system 100 can operate on “autopilot,” surfacing one or more content items using one or more dynamic rules as a way of merchandizing in an intelligent and effective manner.

In one embodiment, the system 100 next causes, at least in part, a mapping of the one or more content items to the one or more collection objects. By way of example, the system 100 can map a “Featured” tab and an “Operator” tab on the home page of a content store (e.g., an application store) to a Home Page Collection and an Operator Collection, respectively; a “featured page content” section to a Standard Collection; “category” and “sub-category” tabs to one or more rule-based Dynamic Collections, which can then be sorted by one or more sort orders (e.g., “free,” “trending,” “recent,” etc.); “banners and/or spotlights” sections to a Banners and Spotlight Collection; a content details page to a Product/User Recommendation Collection, etc. In one embodiment, it is contemplated that by mapping the one or more content items to one or more collection objects, the system 100 can standardize and simplify the merchandizing activities for one or more content store managers, for example. Consequently, a content store manager no longer has to think of the thousands of content items as separate entities for the purpose of merchandizing.

In one or more embodiments, the system 100 then determines at least one root collection object among the one or more collection objects based, at least in part, on the one or more parameters or milieu information. More specifically, in one embodiment, the root collection object is the top level of a defined hierarchy (e.g., in the case of a location-based hierarchy, the top level is the global level) and is often the collection object displayed on the home page of a content store (e.g., an application store). Moreover, in one embodiment, the system 100 uses the at least one root collection object to specify the structure and content displayed in one or more content stores and/or in one or more applications highlighting one or more available content items (e.g., App Highlights by NOKIA).

In one embodiment, the system 100 next processes and/or facilitates a processing of the one or more collection objects to determine one or more sub-collection objects based, at least in part, on the at least one root collection object. By way of example, the one or more sub-collection objects may also be based, at least in part, on one or more parameters or milieu factors (e.g., location, device capability, language or keyword, authorship or operator, etc.). For example, the system 100 may determine that under the root collection object “game” there may be one or more sub-collection objects such as “soccer,” “football,” and “tennis” and under the sub-collection object “soccer” there may still be further sub-collection objects such as “soccer gear” and “soccer training.”

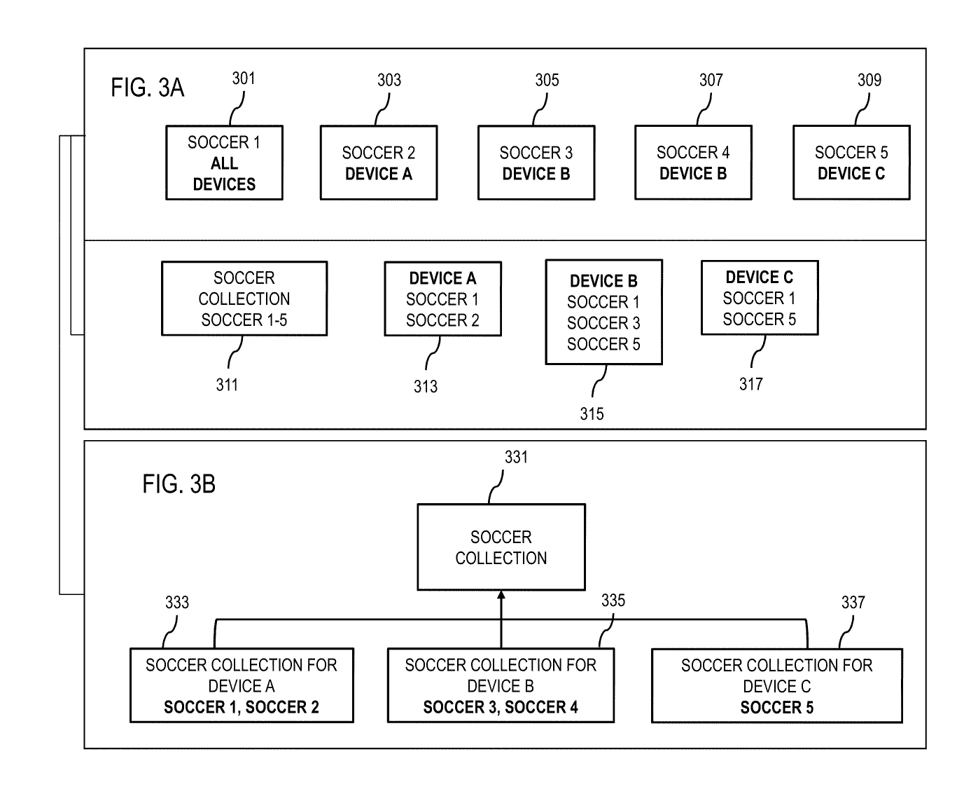

In one or more embodiments, once the system 100 determines the one or more collection objects, the one or more sub-collection objects, or a combination thereof, the system 100 determines at least one collection object hierarchy, at least one collection layout, or a combination thereof based, at least in part, on the mapping, the at least one root collection object, or a combination thereof. In particular, the at least one collection object hierarchy enables the system 100 to manipulate the presentation or visibility of the one or more content items by determining that the at least one root collection object and the one or more sub-collections objects are each targeted for non-overlapping parameters or milieus so that a user only sees the one or more sub-collection objects visible in his or her milieu. An illustrative example of this structure is depicted in FIG. 3B. Moreover, the at least one collection object hierarchy is also based, at least in part, on one or more dynamic criteria, one or more static criteria, or a combination thereof. As a result, the at least one collection object hierarchy can be dynamically built by the system 100 based, at least in part, on a sort order (e.g., “top rated”) or statically built to create one or more locally relevant and/or temporary collection objects. In addition, the at least one collection object hierarchy containing the at least one root collection enables the system 100 to reuse one or more of the one or more collection objects. For example, in the “soccer” example use case, the sub-collection object “soccer training” can be further mapped by the system 100 to at least one other root collection object (e.g., “training”), which may contain the sub-collection objects “soccer training,” and “java training” In addition, the at least one collection object hierarchy may be locally or globally built by the system 100 (e.g., for only a content store in one location or for all content stores worldwide).

In one example use case, at least one conceptual collection object hierarchy includes, at least in part, at least one root collection mapped by the system 100 to one or more sub-collection objects. More specifically, the at least one root collection object (i.e., the top level object) is called “app highlights” (e.g., a curated collection of the newest and most relevant available applications). In this example use case, under the at least one root collection object is a second hierarchical level called “panoramas,” including collection objects “highlights,” “collections,” “new for you,” and “search.” The system 100 then causes, at least in part, a mapping of each panorama with an actual collection object contained within a sorted list within the content store management system of the system 100. Moreover, under the second level “panoramas” is a third hierarchical level called “sub-collection” including “collection 1” mapped to highlights” and “collection 2” mapped to “collections.” In particular, the collection objects “highlights” and “panoramas” can contain one or more content items and one or more sub-collection objects. As a result, a store content manager, for example, may add one or more collection objects to the system 100 and/or remove or reorder the one or more collection objects (e.g., by “dragging and dropping”) to efficiently control the look and feel of the content store.

In one embodiment, the system 100 associates the one or more collection objects with at least one collection object layout, which determines the “look and feel” of one or more collection objects, the one or more content stores, or a combination thereof. More specifically, in one embodiment, the system 100 determines the at least one collection object layout based, at least in part, on the one or more collection objects, the one or more sub-collection objects, or a combination thereof. Moreover, the system 100 includes a number of default layouts (e.g., 4×3, 2×n, 1×n, search, etc.) and enables a content store manager, for example, to add new layouts based, at least in part, on a number of slots (e.g., “12”) and one or more rules (e.g., “backfill,” “defined rules,” etc.). In addition, the system 100 can reuse the at least one collection object layout. For example, the system 100 can associate one or more collection objects with the same at least one collection object layout. Further, when a content store manager, for example, changes the user interface layout, the system 100 can re-evaluate the one or more associated collection objects to determine whether to continue to make them available for a client. As a result, it is contemplated that global or local content store managers, for example, are able to change/configure a user interface layout at will from the back-end of the system 100 without requiring complicated code changes or expensive client upgrades, which is particularly relevant in different parts of the world where users generally prefer one layout design over another.

In one or more embodiments, once the system 100 determines the at least one collection object hierarchy, the at least one collection object layout, or a combination thereof, the system 100 causes, at least in part, a presentation of the one or more collection objects in one or more content stores, a content store management system, or a combination thereof. By way of example, the presentation of the one or more collection objects in the one or more content stores may include, at least in part, a presentation of the one or more associated content items in at least one collection object layout (e.g., default 4×3). In contrast, the presentation of the one or more collection objects in the content store management system may include, at least in part, a data table including a name, an id, a type, an updated date, a validity status, a last export date, a view status, an edit status, a clone status, a deletion status, and an author, for example. Moreover, as previously discussed, the system 100 enables several preview options to help content store managers (e.g., merchandizers) get a sense of content availability in a user's milieu.

More specifically, in one embodiment, the content store management system is a single unified programming tool that is centralized, secure, and access-controlled by the system 100 to manage all of the one or more collection objects, the one or more sub-collection objects, or a combination thereof associated with one or more content stores (e.g., an application store). In particular, the content store management system enables the system 100 to manage users in the system, assign role-based access, and control access at an operational level (e.g., logistical support users (LSUs) are assigned one or more regions and operator users are assigned one or more operators). Moreover, the content store management system enables the system 100 to support multiple content stores with the same programming tool. Further, as previously discussed, it is contemplated that use of the same tool (e.g., the content store management system) by personnel of different authorities and access privileges facilitates better collaboration among the personnel without inhibiting LSUs from operating independently in their own areas on their own content. Consequently, merchandizers are able to better share their experiences of what works and/or what does not work (e.g., if an LSU in a particular location created a collection object that was very successful, an LSU in another location can request to be added to that collection object or clone it for his or her location).

In one embodiment, the system 100 can also cause, at least in part, one or more modifications of at least one user interface element based, at least in part, on the at least one collection object hierarchy, the at least one collection object layout, or a combination thereof. For example, in terms of structure, the at least one collection object layout mirrors the at least one collection object hierarchy and in terms of “look and feel,” the at least one user interface element or client page layout is determined by the at least one collection object layout associated with one or more collection objects. In addition, the content of the at least one user interface element is also determined by the one or more collection objects, the one or more sub-collection objects, or a combination thereof (static or dynamic), which in one embodiment, form the basis of the at least one collection object hierarchy. Therefore, if the system 100 causes, at least in part, a change to the at least one collection hierarchy, the at least one collection object layout, or a combination thereof, then the at least one user interface element will also be changed by the system 100 accordingly. Moreover, it is contemplated that the system 100 can enable a pure configuration of a client user interface (i.e., no code changes are required for a server or the client). Consequently, changes are effective as soon as the one or more relevant caches clear, meaning faster turnaround for content store managers, for example, to view their respective changes.

In one or more embodiments, the system 100 can also cause, at least in part, at least one update of the one or more collection objects, the one or more sub-collection objects, or a combination thereof based, at least in part, on one or more other content items, the one or more dynamic rules, or a combination thereof. As previously discussed, the one or more dynamic rules enable the system 100 to automatically surface and include one or more other content items (e.g., a new application, an update, etc.) that match the specified criteria of the one or more rules associated with the one or more collection objects. As a result, the system 100 implicitly ensures one or more “fresh” content items within the one or more content stores. More specifically, the system 100 can assign each of the one or more new collection objects a new generation id so when it is respectively exported by the content store management system, for example, clients can get incremental updates of the one or more collection objects. In addition, the one or more updates may also include a deactivation of the one or more collection objects by the system 100 so that the one or more collection objects are no longer automatically picked up by the content store management system, for example, to be exported to the one or more content stores.

In embodiment, the system 100 determines one or more blacklists of content, one or more whitelists of content, or a combination thereof associated with the one or more content items, the one or more collection objects, the one or more sub-collection objects, or a combination thereof. In particular, the system 100 enables content store managers, for example, to specify one or more content items for specific product promotions (i.e., whitelists) or to prohibit one or more content items from being associated with one or more collection objects corresponding to one or more content stores (i.e., blacklists). More specifically, a blacklist collection is a specific collection that defines content to be removed from some or all parts of a content store either because the underlying content is utterly offensive (i.e., blacklisting globally) or because the content is offensive in certain regions/countries or the nomenclature is offensive in some languages/cultures (i.e., targeted blacklisting). The system 100 can also determine to blacklist one or more content items that may be inconvenient on one or more devices either due to size or resource requirement (e.g., if the content item's file size is large and generally fails to download in a limited bandwidth operator network or if the content item requires considerable memory/processing capabilities to ensure a satisfactory user experience). Moreover, the system 100 can determine to blacklist one or more content items in favor of a similar branded content item that is being promoted during a particular time period or for the foreseeable future.

In one embodiment, the system 100 then processes and/or facilitates a processing of the one of the one or more blacklists, the one or more whitelists, or a combination thereof to modify the at least one collection object hierarchy, the at least one collection object layout, or a combination thereof. In particular, while the one or more blacklisted content items may still appear in the content store management system, for example, the system 100 prevents such content from being presented or viewed in the one or more relevant content stores. In contrast to blacklisted content, the system 100 can promote one or more content items designated by the system 100 for whitelisting by mapping the one or more content items within one or more prominent collection objects (e.g., the Features Collection, the Banner and Spotlight Collection, etc.). By way of further example, the system 100 can also determine to blacklist content by location within the one or more content stores (e.g., preventing the one or more content items, the one or more collection objects, or a combination thereof from appearing on the home page of a content store); by publisher or by rule (e.g., if one or more publishers are identified as rogue users that “spam” the system 100 with one or more substandard content items); and by a time bound promotion (e.g., if a merchandizer wants to promote a relatively new content item that is in direct competition with an existing popular content item).

In one or more embodiments, the system 100 can determine the one or more collection objects, the one or more sub-collection objects, or a combination thereof based, at least in part, on at least one faceted search. By way of example, a faceted search enables the system 100 to determine static content for one or more existing collection objects and/or determine one or more dynamic rules for one or more collection objects. More specifically, a content store manager, for example, may define the one or more parameters (or facets) of the one or more dynamic rules (e.g., a category, a publisher, a price point, etc.), which may help refine one or more searches of the one or more content items, the one or more collection objects, or a combination thereof associated with one or more content stores.

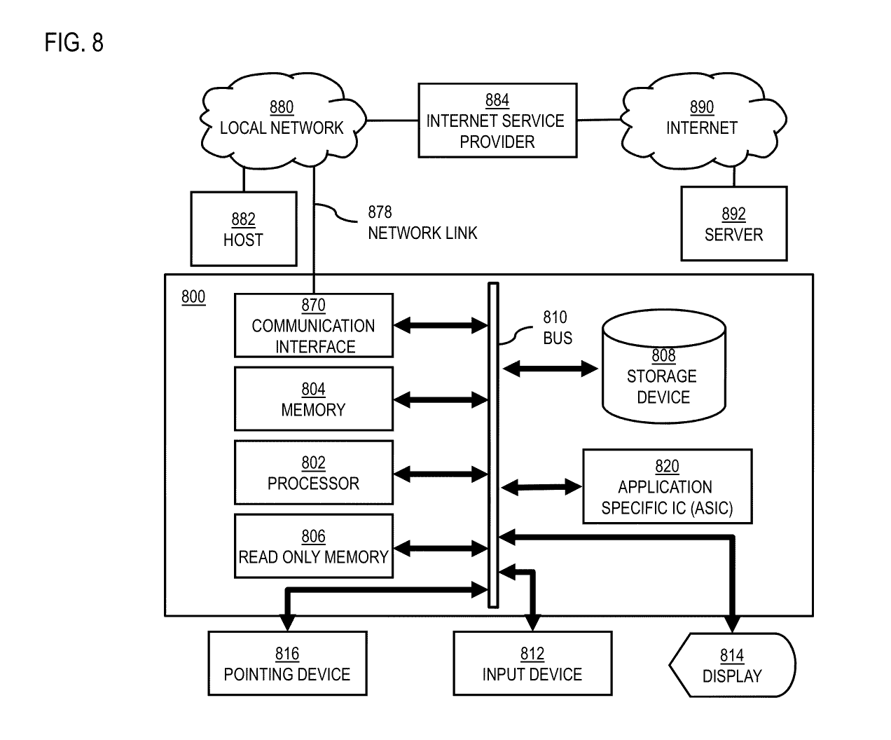

As shown in FIG. 1, the system 100 comprises one or more user equipment (UE) 101a-101m (e.g., a mobile device) (also collectively referred to as UEs 101) having connectivity to a collection management platform 103 via a communication network 105. The UEs 101 include or have access to an online store application 107 that may feature a link for enabling accessing of the collection management platform 103 by one or more content store managers, for example, based on their respective level of access. In one embodiment, the collection management platform 103 is a computer system (e.g., a server) as described with respect to FIG. 8 below.

In one embodiment, the collection management platform 103 may include or be associated with at least one collections database 109. In one example embodiment, the collections database 109 may exist in whole or in part within the collection management platform 103, or independently. More specifically, the collections database 109 may include one or more content catalogs including one or more content items (e.g., mobile applications) as well as one or more collection objects, one or more sub-collection objects, or a combination thereof (e.g., a Home Page Collection, a Theme Pack Collection, a Banners and Spotlight Collection, a Blacklist/Whitelist Collection, etc.) including one or more static rules, one or more dynamic rules, one or more preview rules, or a combination thereof associated with the one or more collection objects. The collections database 109 may also include one or more parameters associated with the one or more dynamic rules (e.g., one or more parameters based on location, device capability, language or keyword, author or operator, etc.). Further, the collections database 109 may also include at least one default collection object layout (e.g., 4×3, 1×n, 2×n, search, etc.).

The UEs 101 are also connected to a services platform 111 (e.g., a content store) via the communication network 105. The services platform 111 includes one or more services 113a-113n (also collectively referred to as services 113) for facilitating the content store (e.g., payment services, compliance services, user feedback services, etc.). The UEs 101, the services platform 111, and the services 113 also have connectivity to one or more content providers 115a-115p (also collectively referred to as content providers 115) via the communication network 105. The content providers 115 may provision a wide variety of content to the components of the system 100 including, at least in part, one or more content catalogs including one or more content items (e.g., mobile applications) as well as one or more content items and/or one or more other content items (e.g., an update for a particular application).

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

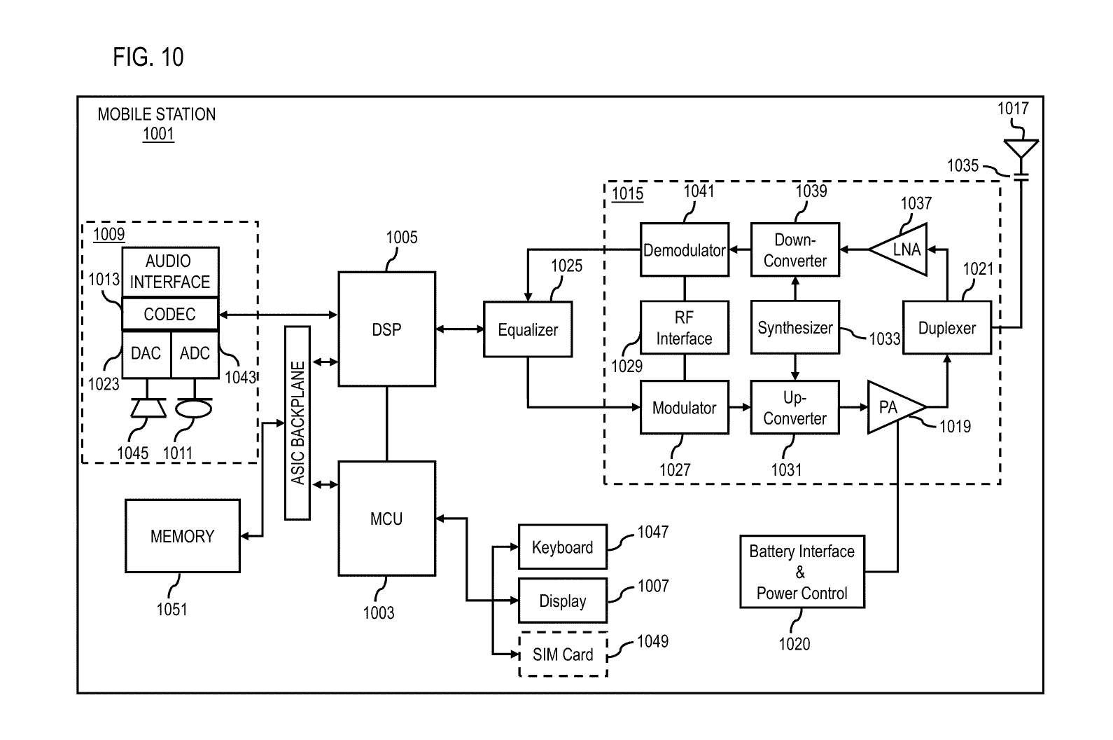

The UEs 101 are any type of mobile terminal, fixed terminal, or portable terminal including a mobile device, phone, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is noted that, in the various embodiments, described herein the term mobile device is used synonymously with the UEs 101, mobile terminal, mobile phone, and/or any other mobile devices listed above. It is also contemplated that the UEs 101 can support any type of interface to the user (such as “wearable” circuitry, etc.). In one embodiment, the UEs 101 are mobile devices (e.g., handsets, mobile phones, etc.) as described with respect to FIG. 10 below.

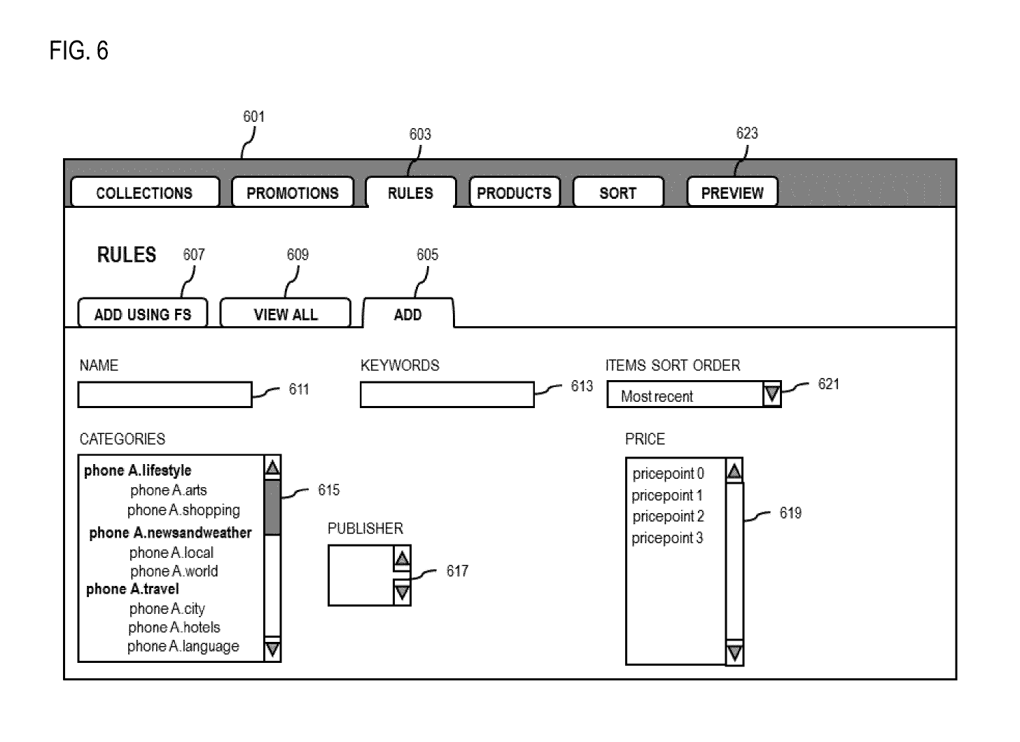

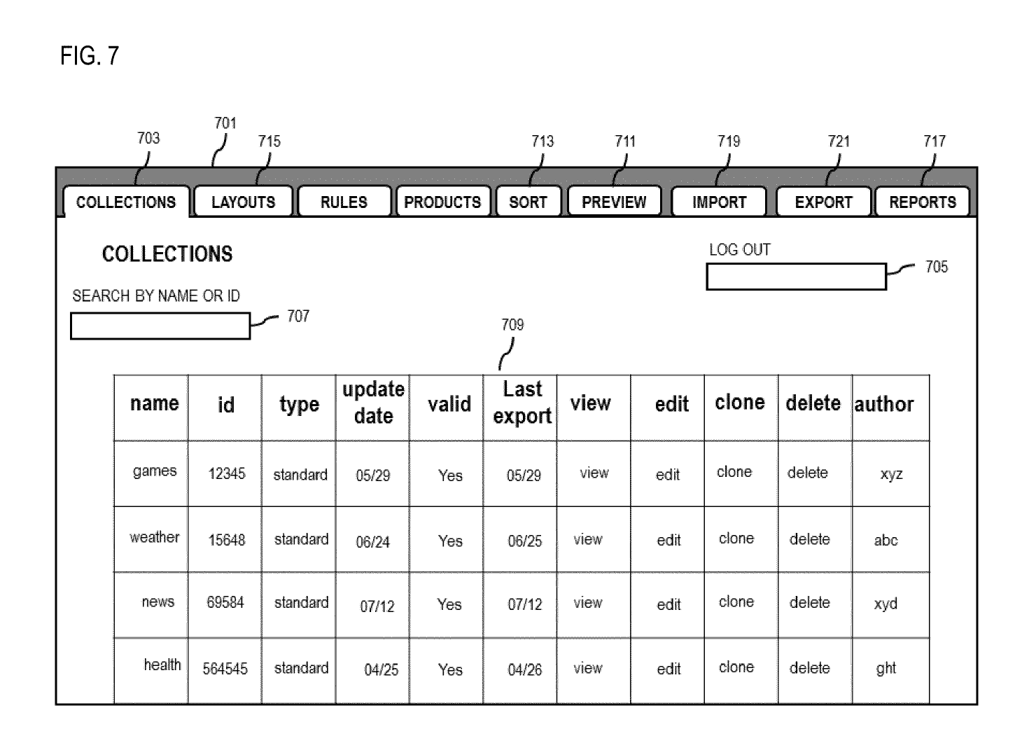

In one embodiment, the collection management platform 103 first determines one or more content items from one or more content catalogs. In particular, the collection management platform 103 can import data associated with the one or more content catalogs and all of its accessory objects from one or more authors (e.g., developers) or operators (e.g., mobile phone service provider) using a content store management system, for example. An illustrative example of a content store management system is depicted in FIGS. 6 and 7. More specifically, the one or more content items, for example, include online services or content such as mobile applications (e.g., a puzzle videogame, a soccer application, a gardening application, etc.) that are designed to run on a UE 101 such as a mobile device (e.g., a mobile phone or a tablet). By way of example, the collection management platform 103 can determine the one or more content items based, at least in part, on one or more static rules, one or more dynamic rules, or a combination thereof.

In one embodiment, the collection management platform 103 next determines the one or more static rules, the one or more dynamic rules, or a combination thereof associated with the one or more content items, one or more collection objects, or a combination thereof based, at least in part, on one or more parameters. As previously discussed, the one or more parameters may be based, at least in part, on a location, a device capability, a language or keyword, an author or an operator, etc. In addition, the collection management platform 103 includes one or more preview rules to enable content store managers, for example, to see the one or more content items associated with a particular rule before the collection management platform 103 generates the corresponding one or more collection items.

In one or more embodiments, the collection management platform 103 then causes, at least in part, a generation of one or more collection objects based, at least in part, on the one or more static rules, the one or more dynamic rules, or a combination thereof. More specifically, the collection management platform 103 can consider everything in a content store as one or more collection objects. Moreover, the collection management platform 103 can assign each of the one or more collection objects a name/description or id that can be localized in different languages for different markets/regions. In addition, the collection management platform 103 may use one or more collection objects as building blocks for one or more other collection objects. For example, the collection management platform 103 can construct a collection that is an amalgamation of a price point collection, an entertainment collection, and a sorted by “most recent” collection. Further, the collection management platform 103 enables a content store manager, for example, to input an id, a sub-type, a keyword, a tag, etc. into a content store management system, for example, to provide better internal organization and classification to help promote more efficient searches in the future.

In one embodiment, the collection management platform 103 next causes, at least in part, a mapping of the one or more content items to the one or more collection objects. For example, the collection management platform 103 can map a “Featured” tab and an “Operator” tab on the home page of a content store (e.g., an application store) to a Home Page Collection and an Operator Collection, respectively, “banners and/or spotlights” sections to a Banners and Spotlight Collection, etc. In particular, it is contemplated that by mapping the one or more content items to one or more collection objects, the collection management platform 103 can standardize and simplify the merchandizing activities for the one or more global and local content store managers.

In certain embodiments, the collection management platform 103 then determines at least one root collection object among the one or more collection objects based, at least in part, on the one or more parameters or milieu information. Moreover, in one embodiment, the collection management platform 103 uses the at least one root collection object to specify the structure and content displayed in one or more content stores and/or one or more applications highlighting one or more available content items (e.g., App Highlights by NOKIA). In one embodiment, the collection management platform 103 next processes and/or facilitates a processing of one or more collection objects to determine one or more sub-collection objects based, at least in part, on the at least one root collection object.

In one or more embodiments, once the collection management platform 103 determines the one or more collection objects, the one or more sub-collection objects, or a combination thereof, the collection management platform 103 determines at least one collection object hierarchy, at least one collection object, or a combination thereof. In particular, the at least one collection object hierarchy enables the collection management platform 103 to manipulate the presentation or visibility of the one or more content items by determining that the at least one root collection object and the one or more sub-collection objects are each targeted for non-overlapping parameters or milieus so that a user only sees the one or more sub-collection objects visible in his or her milieu.

In one embodiment, the collection management platform 103 associates the one or more collection objects with at least one collection object layout, which determines the “look and feel” of one or more collection objects, the one or more content stores, or a combination thereof. In particular, in one embodiment, the collection management platform 103 determines the at least one collection object layout based, at least in part, on the one or more collection objects, the one or more sub-collection objects, or a combination thereof. Moreover, the collection management platform 103 includes and/or has access to a number of default layouts (e.g., 4×3, 2×n, 1×n, search, etc.) and can enable a content store manager, for example, to add one or more new layouts. In addition, the collection management platform 103 can reuse the at least one collection object layout (i.e., the collection management platform 103 can map one or more collection objects with the same at least one collection object layout).

In one or more embodiments, once the collection management platform 103 determines the at least one collection object hierarchy, the at least one collection object layout, or a combination there, the collection management platform 103 causes, at least in part, a presentation of the one or more collection objects in one or more content stores, a content store management system, or a combination thereof. As previously discussed, the presentation of the one or more collection objects in the one or more content stores may include, at least in part, a presentation of the one or more mapped content items in at least one collection object layout (e.g., default 4×3). In contrast, the presentation of the one or more collection objects in the content store management system may include, at least in part, a data table including a name, an id, a type, an updated date, a validity status, a last export date, a view status, an edit status, a clone status, a deletion status, and an author, for example.

In one embodiment, the collection management platform 103 can also cause, at least in part, one or more modifications of at least one user interface element based, at least in part, on the at least one collection object hierarchy, the at least one collection object layout, or a combination thereof. For example, in terms of structure, the at least one collection object layout mirrors the at least one collection object hierarchy and in terms of “look and feel,” the at least one user interface element or client page layout (e.g., of a UE 101) is determined by the at least one collection object layout associated with one or more collection objects. In addition, the content of the at least one user interface element is also determined by the collection management platform 103 by the one or more collection objects, the one or more sub-collection objects, or a combination thereof, which in one embodiment, form the basis of the at least one collection object hierarchy. Therefore, if the collection management platform 103 causes, at least in part, a change to the at least one collection object hierarchy, the at least one collection object layout, or a combination thereof, then the at least one user interface element will also be changed by the collection management platform 103 accordingly.

In one or more embodiments, the collection management platform 103 can also cause, at least in part, at least one update of the one or more collection objects, the one or more sub-collection objects, or a combination thereof based, at least in part, on one or more other content items, the one or more dynamic rules, or a combination thereof. As previously discussed, the one or more dynamic rules enable the collection management platform 103 to automatically surface and include one or more other content items (e.g., a new application, an update, etc.) that match the specified criteria of the one or more dynamic rules associated with the one or more collection objects. As a result, the collection management platform 103 implicitly ensures one or more “fresh” content items within the one or more content stores. Further, the one or more updates may also include a deactivation of the one or more collection objects by the collection management platform 103 so that the one or more collection objects are no longer automatically picked up by the content store management system, for example, to be exported to the one or more content stores.

In one embodiment, the collection management platform 103 determines one or more blacklists of content, one or more whitelists of content, or a combination thereof associated with the one or more content items, the one or more collection objects, the one or more sub-collection objects, or a combination thereof. More specifically, the collection management platform 103 enables content store managers, for example, to direct content for specific product promotions (i.e., whitelists) or to prohibit content associated with one or more collection objects related to one or more content stores (i.e., blacklists). By way of example, the collection management platform 103 can determine to blacklist content that is offensive (globally or for a particular location/language), inconvenient on one or more devices, or that is in competition with a similar branded content item that is being promoted during a particular time period or for the foreseeable future.

In one or more embodiments, the collection management platform 103 then processes and/or facilitates a processing of the one or more blacklists, the one or more whitelists, or a combination thereof to modify the at least one collection object hierarchy, the at least one collection object layout, or a combination thereof. In particular, while the one or more blacklisted content may still appear in the content store management system, for example, the collection management platform 103 prevents such content from being presented or viewed in the one or more relevant content stores. In contrast to blacklisted content, the collection management platform 103 can promote one or more content items designated by the collection management platform 103 for whitelisting by mapping the one or more content items with one or more prominent collection objects (e.g., the Features collection, the Banner and Spotlight Collection, etc.). By way of further example, the collection management platform 103 can also determine to blacklist content by location within the one or more content stores, by publisher or rule, and/or by a time bound promotion.

In one embodiment, the collection management platform 103 can also determine the one or more collection objects, the one or more sub-collection objects, or a combination thereof based, at least in part, on at least one faceted search. In particular, a faceted search enables the collection management platform 103 to determine static content for one or more existing collection objects and/or one or more dynamic rules for one or more collection objects. Further, a content store manager, for example, may specify the one or more parameters (or facets) of the one or more dynamic rules (e.g., a category, a publisher, a price point, etc.), which may help refine one or more searches of the one or more content items, the one or more collection objects, or a combination thereof associated with one or more content stores.

By way of example, the UEs 101, collection management platform 103, the services platform 111, and the content provider 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

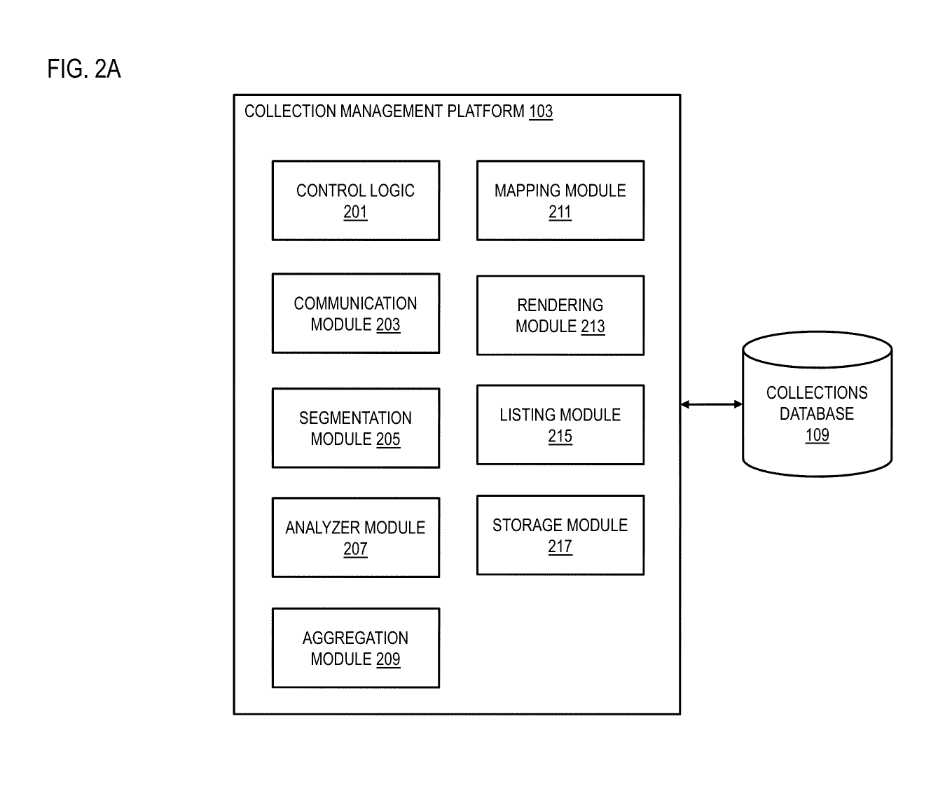

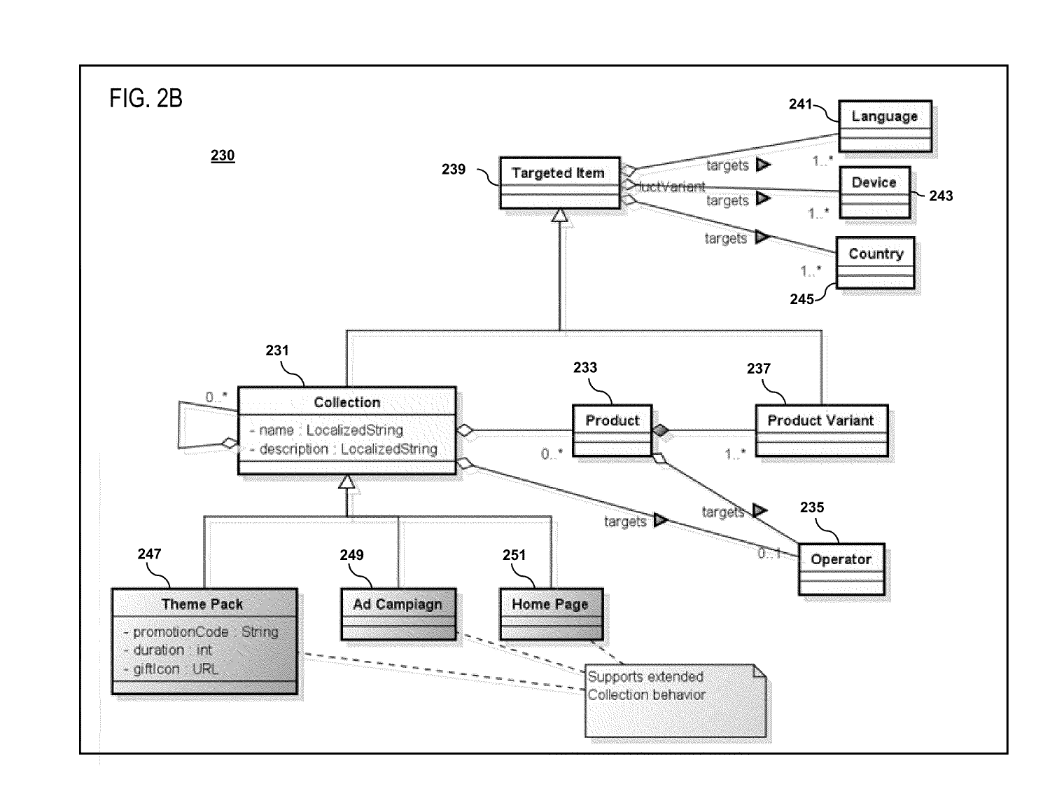

FIG. 2A is a diagram of the components of a collection management platform 103, according to one embodiment. By way of example, the collection management platform 103 includes one or more components for mapping relevant and up-to-date online content to content collections using a single programming tool. It is contemplated that the functions of these components may be combined in one or more components or performed by other components of equivalent functionality. In this embodiment, the collection management platform 103 includes a control logic 201, a communication module 203, a segmentation module 205, an analyzer module 207, an aggregation module 209, a mapping module 211, a rendering module 213, a listing module 215, and a storage module 217.

In one embodiment, the control logic 201 oversees tasks, including tasks performed by the communication module 203, the segmentation module 205, the analyzer module 207, the aggregation module 209, the mapping module 211, the rendering module 213, the listing module 215, and the storage module 217. For example, although the other modules may perform the actual task, the control logic 201 may determine when and how those tasks are performed or otherwise direct the other modules to perform the task.

The communication module 203, in certain embodiments, is used for communication between the UEs 101, the collection management platform 103, the collections database 109, the services platform 111, the services 113, and the content providers 115. The communication module 203 may also be used to communicate commands, requests, data, etc. Further, the communication module 203, in connection with the aggregation module 209, also may be used to determine one or more content catalogs (e.g., importing a product catalog from a developer or an operator) as well as one or more other content items (e.g., an update for a particular application).

In one embodiment, the segmentation module 205 is used to determine one or more content items from one or more content catalogs. More specifically, the segmentation module 205 can import data associated with one or more content catalogs and all of its accessory objects from one or more authors and/or one or more operators into a content store management system, for example. Moreover, the segmentation module 205 can determine the one or more content items based, at least in part, on one or more static rules, one or more dynamic rules, or a combination thereof. The segmentation module 205 may also be used to process and/or facilitate a processing of the one or more collection objects to determine one or more sub-collection objects based, at least in part, on the at least one root collection object. For example, if the analyzer module 207 determines that the at least one root collection object is “soccer,” then the segmentation module 205 may then determine in turn that the one or more sub-collection objects include, for example, “soccer gear” and “soccer training.”

In one or more embodiments, the analyzer module 207 is used to determine one or more static rules, one or more dynamic rules, or a combination thereof associated with the one or more content items, the one or more collection objects, or a combination thereof based, at least in part, on one or more parameters. By way of example, the analyzer module 207 can determine the one or more rules based, at least in part, on a search of the content store management system associated with the collection management platform 103, the collections database 109, or a combination thereof based, at least in part, on a saved name or one or more parameters. Using the same logic, the analyzer module 207 may also be used to determine at least one root collection object among the one or more collection objects. Further, the analyzer module 207 also may be used to determine at least one collection object hierarchy, at least one collection object layout, or a combination thereof based, at least in part, on the mapping, the at least one root collection object, or a combination thereof.

In one embodiment, the aggregation module 209 is used to cause, at least in part, a generation of one or more collection objects based, at least in part, on the one or more static rules, the one or more dynamic rules, or a combination thereof. In particular, the aggregation module 209 collects and filters the one or more content items contained within one or more imported content catalogs based, at least in part, one or more explicit definitions (e.g., application “x”) and/or one or more dynamic parameters (e.g., a category, a price point, a publisher, etc.). The aggregation module 209, in connection with the communication module 203, may also be used to cause, at least in part, at least one update of the one or more collection objects, the one or more sub-collection objects, or a combination thereof based, at least in part, on one or more other content items, the one or more dynamic rules, or a combination thereof. More specifically, the one or more dynamic rules (e.g., free content items from developer “R”) enable the aggregation module 209 to automatically surface (e.g., based on a name/description or id) and include the one or more other content items (e.g., a new application, an update, etc.) that match the criteria of the one or more rules associated with the one or more collection objects. In addition, the aggregation module 209 also may be used to determine the one or more collection objects, the one or more sub-collection objects, or a combination thereof based, at least in part, on at least one faceted search. By way of example, the aggregation module 209 can search the one or more static collections and/or the one or more dynamic collections based, at least in part, on one or more parameters to narrow down the result set to determine the one or more specific collection objects, the one or more specific sub-collection objects, or a combination thereof.

In one or more embodiments, the mapping module 211 is used to cause, at least in part, a mapping of the one or more content items to one or more collection objects. By way of example, the mapping module 211 can map a “Featured” tab or link and an “Operator” tab or link on the content store home page to a Home page Collection and an Operator Collection, respectively; a “featured page content” section to a Standard Collection; “category” and “sub-category” tabs to one or more rule-based Dynamic Collections; “banners and/or spotlights” sections to a Banners and Spotlight Collection; etc.

The rendering module 213, in certain embodiments, is used to cause, at least in part, a presentation of the one or more collection objects in one or more content stores, a content store management system, or a combination thereof. By way of example, the rendering module 213 can present the one or more collection objects in the one or more content stores as one or more content items associated with one or more collection objects using at least one collection object layout (e.g., default 4×3) and the one or more content items may then be viewed in a user interface element of a user device (e.g., a tablet). In addition, the rendering module 213 can present the one or more collection objects in the content store management system as a data table including, at least in part, a name, an id, a type, for example. Further, the rendering module 213 can enable a content store manager, for example, to preview the one or more collection objects based, at least in part, on one or more preview options (i.e., the manager is able to get a sense of content availability in a particular milieu). The rendering module 213 may also be used to cause, at least in part, one or more modifications of at least one user interface element based, at least in part, on the at least one collection object hierarchy, the at least one collection layout, or a combination thereof.

In one or more embodiments, the listing module 215 determines one or more blacklists of content, one or more whitelists of content, or a combination thereof associated with the one or more content items, the one or more collection objects, the one or more sub-collection objects, or a combination thereof. More specifically, the listing module 215 enables a content store manager to direct content to specific product promotions (e.g., whitelists) or to prohibit content in the one or more collection objects associated with one or more content stores (e.g., blacklists). The listing module 215 may also be used to process and/or facilitate a processing of the one or more blacklists, the one or more whitelists, or a combination thereof to modify the at least one collection object hierarchy, the at least one collection object layout, or a combination thereof. In particular, while one or more blacklisted content items may still appear in the content store management system, for example, the listing module 215, in connection with the rendering module 213, may prevent such content from being presented or viewed in the one or more content stores. In contrast, the listing module 215, in connection with the rendering module 213, can promote one or more content items designated as whitelisted content by mapping the one or more content items with one or more prominent collection objects (e.g., the Features Collection, the Banner and Spotlight Collection, etc.).

The storage module 217, in certain embodiments, is used to manage the storage of the one or more content catalogs, the one or more content items (e.g., applications), or a combination thereof stored in the collections database 109. The storage module 217 may also be used to manage the storage of the one or more collection objects, the one or more sub-collection objects, or a combination thereof also stored in the collections database 109. In addition, the storage module 217 also may be used to manage the storage of the one or more static rules, the one or more dynamic rules, the one or more preview rules, or a combination thereof also stored in the collections database 109. Further, the storage module 217 may also be used to manage the storage of the one or more parameters associated with the one or more dynamic rules as well as the one or more default collection object layouts also stored in the collections database 109.

FIG. 2B is a diagram of a collection object model employed by the collection management platform 103, according to one embodiment. As shown, the object model 230 includes a collection of objects and/or classes conforming to a specific object oriented programming language (e.g., Java). For example, a collection class 231 (i.e., a collection object) may be defined to include attributes “name” and “description” corresponding to the name and description of an instance of the collection object. Associated with the collection class 231, as linked, are a product class 233 (i.e., a content item) and an operator class 235. These classes 233 and 235 correspond to an instance of a product and an operator, respectively. By way of example, multiple instances of a product and/or an operator may be linked to a single collection class (e.g., collection class 231). Moreover, in one embodiment, a collection object or collection class contains one or more product classes (e.g., product class 233) and/or one or more sub-collection or sub-collection classes (not shown for illustrative purposes). In particular, the at least one collection object hierarchy is built on the one or more sub-collections of the one or more corresponding collections. In addition, a product variant class 237 may be further linked to the product class 233 for enabling variations of products (e.g., price variation, color variation, feature variation, etc.) to be further associated with an instance of a collection (e.g., collection class 231).

A top level class 239, classified as a targeted item, is linked to the collection class 231 or product variant class 237. By way of example, the targeted item class 239 may correspond to a root collection object. Moreover, both the collection class 231 and the product variant class 237 have targeting information that is linked to a language class 241, a device class 243 (e.g., a tablet), a country class 245, and an operator class 235, which correspond to at least one collection object hierarchy. For example, the targeted classes 235 and 241-245 may include attributes for matching one or more parameters or milieu criteria of a given user and/or device attempting to activate a content item or application of one or more collection objects. More specifically, the collection class 231 can be either static (i.e., content is explicitly defined) or dynamic (i.e., content is defined is defined by a rule). For example, a dynamic rule may specify a search word (e.g., “soccer”), a sort order (e.g., “top rated”), a category (e.g., “games”), a price point (e.g., “free”), or a combination thereof.

In one embodiment, the collection class 231 is also linked to a theme pack class 247, an advertisement campaign class 249, and a home page class 251. More specifically, the theme pack class 247 is further defined to include a collection of promotional items (e.g., premium content offered at a discount). The advertisement campaign class 249 and the home page class 251 support one or more instances of an advertisement campaign (e.g., a marketing message) or website featuring online store content (e.g., an application store). Moreover, the home page class 251 is a special type of collection and is also called a Featured Collection. Other types of collection classes include, at least in part, a Standard Collection featuring editorial items (e.g., a Holiday collection, a travel collection, etc.); an Operator Collection (e.g., operator promoted content items); a Banner and Spotlight Collection (e.g., content items prominently displayed on the home page of the content store); etc. In one or more embodiments, the object model 230 may also include category pages as a collection (e.g., “utilities,” “top free,” etc.), a Blacklist Collection (e.g., prohibited content) or Whitelist Collection (e.g., promoted content). In particular, the blacklist collection, like one or more other collections may be targeted for one or more country classes 245, device classes 243, language classes 241, and/or operator classes 235. Moreover, the blacklist collection can have a static list of content or be associated with one or more dynamic rules to specify exclusion criteria. It is further noted that each of these classes 247-251, for example, support extended content collection behavior. Consequently, a content store manager, for example, no longer has to think of the thousands of products or applications as separate entities to merchandize because everything is mapped to the collection classes (e.g., collection class 231) by the object model 230.

FIGS. 3A and 3B are diagrams of a collection object hierarchy for a single operator with different sub-collections for different user devices, according to one embodiment. As shown, FIG. 3A illustrates one or more content items (e.g., soccer applications 301-309) related to the sport of soccer that work on one or more devices (e.g., device “A”, device “B”, and device “C”). More specifically, in one example use case, the soccer application 301 works on all of the devices, whereas the soccer application 303 only works on device “A”, the soccer applications 305 and 307 only work on device “B”, and the soccer application 309 only works on device “C”.

In one embodiment, the system 100 first determines the one or more content items (e.g., soccer applications 301-309) from one or more content catalogs. In particular, the one or more content items may be completely different games or they may be variations of the same game (e.g., a demo version or a full-feature version). The system 100 next determines one or more static rules, one or more dynamic rules, or a combination thereof associated with the one or more content items, one or more collection objects, or a combination thereof based, at least in part, on one or more parameters. In this example use case, the one or more parameters may pertain to device capability of the devices “A”-“C” (e.g., processing power, display size, etc.). The system 100 then causes, at least in part, a generation of one or more collection objects (e.g., “Soccer Collection” 311) containing the one or more content items (e.g., soccer applications 301-309). In this example use case, rather than causing, at least in part, a mapping of the one or more content items to the one or more collection objects (i.e., ignoring the full potential of the system 100), the system 100 simply causes, at least in part, a presentation of the one or more content items in one or more content stores, for example, depending on which one of the one or more devices a user is using as depicted by elements 313, 315, and 317, respectively.

In contrast, as shown, FIG. 3B illustrates a benefit of mapping of the one or more content items to one or more collection objects and more importantly determining at least one root collection object among the one or more collection objects based, at least in part, on one or more parameters. In this example use case, it is determined that the soccer applications 301 and 302 are not very sophisticated. Therefore, it is contemplated that the soccer applications 301 and 302 should only be marketed towards low end user devices (e.g., a mobile phone), and not on more powerful devices such as a smartphone or a tablet. In one embodiment, once the system 100 determines at least one root collection object (e.g., “Soccer Collection” 331), the system 100 processes and/or facilitates a processing of the one or more collection objects to determine one or more sub-collection objects (e.g., sub-collection objects 333-337) based, at least in part, on the at least one collection object, wherein the presentation in a content store, for example, is based, at least in part, on the one or more sub-collections. Consequently, if a user is using device “A”, he or she will only see the sub-collection object 333; if the user is using device “B”, he or she will only see the sub-collection object 335; and if the user is using device “C”, he or she will only see the sub-collection object 337. As a result, the system 100 enables content store managers, for example, to better control what content appears on what devices.

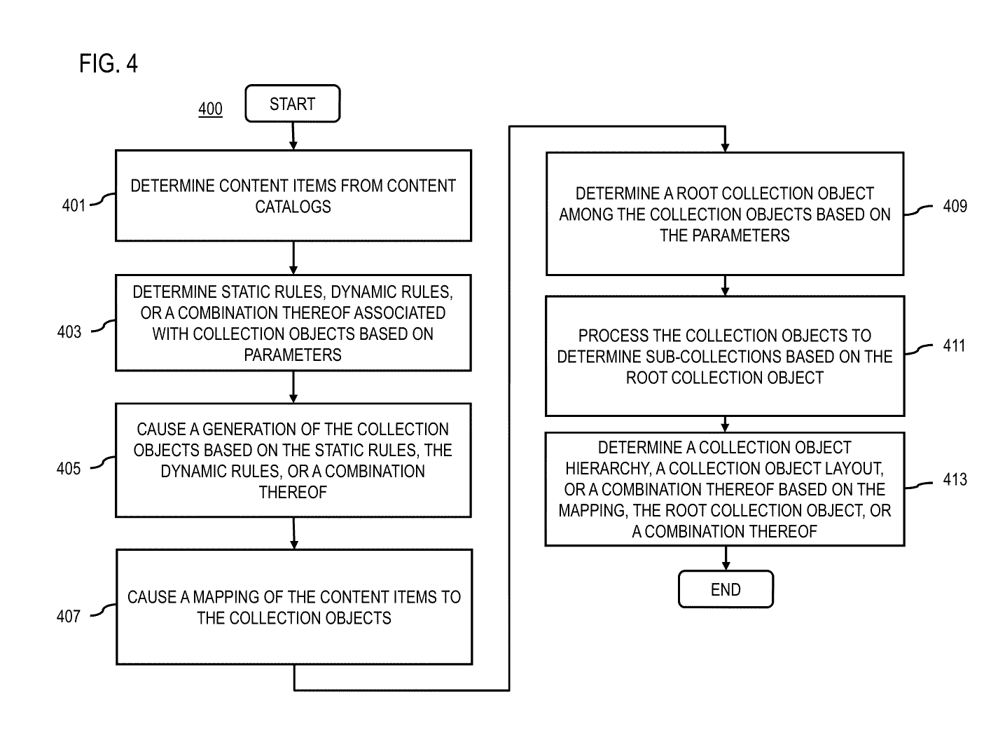

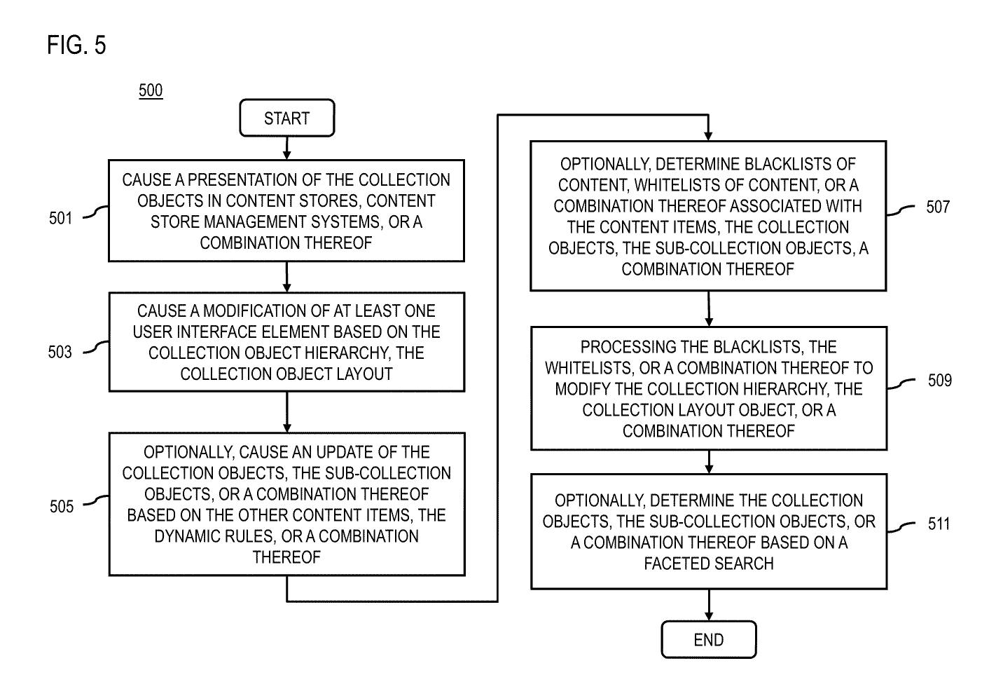

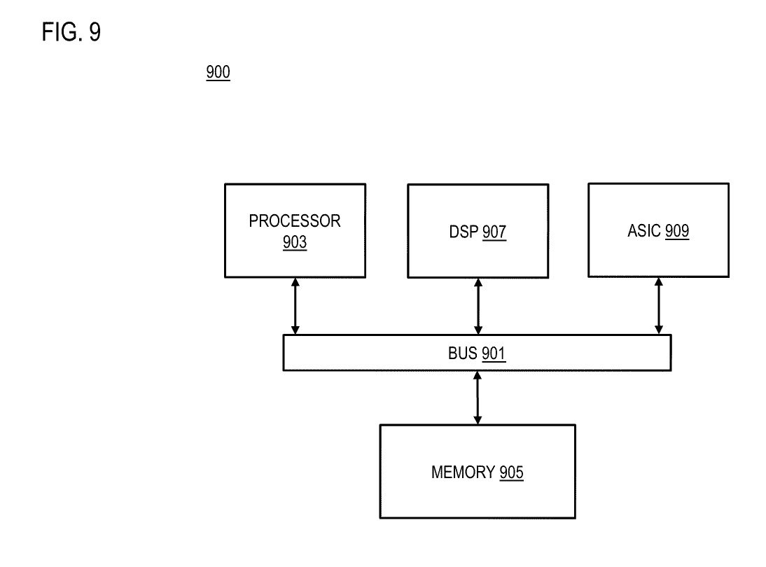

FIGS. 4 and 5 are flowcharts of processes for mapping relevant and up-to-date online content to content collections using a single programming tool, according to one embodiment. FIG. 4 depicts a process of mapping the one or more content items (e.g., an application). In one embodiment, the collection management platform 103 performs the process 400 and is implemented in, for instance, a chip set including a processor and a memory as shown in FIG. 9. In step 401, the collection management platform 103 determines one or more content items from one or more content catalogs. By way of example, the one or more content items, for example, include online services or content such as mobile applications (e.g., a puzzle videogame, a soccer application, a gardening application, etc.) that are designed to run on a user device such as a mobile device (e.g., a mobile phone or a tablet). In addition, the one or more content items may contain several content variants (e.g., a free version, a paid version, etc.). In particular, the collection management platform 103 imports the one or more content catalogs and all of its accessory objects from one or more authors (e.g., a developer) or an operator (e.g., a mobile phone service provider) using a content store management system, for example. By way of example, the collection management platform 103 can determine the one or more content items based, at least in part, on one or more static rules, one or more dynamic rules, or a combination thereof.

In step 403, the collection management platform 103 determines one or more static rules, one or more dynamic rules, or a combination thereof associated with the one or more content items, the one or more collection objects, or a combination thereof based, at least in part, on one or more parameters. In particular, the rules are specified or applied at a global, country, regional (local) level, or a combination thereof (e.g., filtering content items based, at least in part, on one or more criteria). In addition, the rules specify one or more filters or executions for defining the means of content selection or programming. More specifically, the one or more static rules pertain to explicitly defined content (i.e., content or applications known in advance). In contrast, as previously discussed, the one or more dynamic rules are based, at least in part, on location (e.g., a content store accessible in North America versus a content store accessible in the Middle East), device capabilities (e.g., processing power, display size, etc.), language or keywords, authorship (e.g., a developer) or operators (e.g., a mobile phone service provider), etc. In addition, in one example use case, the filter criteria may also be based, at least in part, on a content category (e.g., “lifestyle,” “news and weather,” “travel,” etc.), a price point (e.g., “free,” “paid,” etc.), a publisher, a billing method (e.g., “credit card only”), an item sort order (e.g., “most recent”), a feed type (e.g., “user recommendations”), etc. Further, the collection management platform 103 includes one or more preview rules to enable content store managers, for example, to see the one or more content items associated with a particular rule before the collection management platform 103 generates the corresponding one or more collection objects.

In step 405, the collection management platform 103 causes, at least in part, a generation of the one or more collection objects based, at least in part, on the one or more static rules, the one or more dynamic rules, or a combination thereof. By way of example, the one or more collection objects may include, for example, any grouping of one or more content items or any grouping of one or more sub-collection objects sharing one or more common attributes. More specifically, the collection management platform 103 can consider everything in a content store (e.g., an application store) as one or more collection objects. The one or more collection objects may be static (i.e., explicitly defined) or dynamic (i.e., determined at runtime based on a rule). Moreover, the one or more collection objects may be of several types, for example, a Standard Collection, which is an aggregation of one or more editorial items (e.g., a Holiday Collection, a Travel Collection, etc.); an Operator Collection (e.g., operator promoted content items); a Theme Pack Collection (e.g., promotional content items such as premium content offered at a discount); a Banner and Spotlight Collection (e.g., content items prominently displayed on the home page or a landing page of a content store); etc. In one or more embodiments, the collection management platform 103 may also consider the home page as a collection (e.g., “featured content”), category pages as a collection (e.g., “utilities,” “top free,” etc.) blacklist (e.g., prohibited content) or whitelist (e.g., promoted content) items as respective collections, etc. Further, the collection management platform 103 may use one or more collection objects as building blocks for one or more other collection objects. For example, the collection management platform 103 can construct a collection object that is an amalgamation of a price point collection, an entertainment collection, and a sorted by “most recent” collection.

In step 407, the collection management platform 103 causes, at least in part, a mapping of the one or more content items to one or more collection objects. In one example use case, the collection management platform 103 can map a “Featured” tab and an “Operator” tab on the home page of a content store (e.g., an application store) to a Home Page Collection and an Operator Collection, respectively; a “featured page content” section to a Standard Collection; “category” and “sub-category” tabs to one or rule-based Dynamic Collections, which can then be sorted by one or more sort order (e.g., “free,” “trending,” “recent,” etc.); “banners and/or spotlights” sections to a Banners and Spotlight Collection; a content details page to a Product/User Recommendation Collection, or a combination thereof. In one embodiment, it is contemplated that by mapping the one or more content items to one or more collection objects, the collection management platform 103 can standardize and simplify the merchandizing activities for one or more content store managers. Consequently, a content store manager, for example, no longer has to think of the thousands content items as separate entities for the purpose of merchandizing.

In step 409, the collection management platform 103 determines at least one root collection object among the one or more collection objects based, at least in part, on the one or more parameters. By way of example, in one embodiment, the root collection object is the top level of a defined hierarchy (e.g., in the case of a location-based hierarchy, the top level is the global level) and is often the collection object displayed on the home page of a content store (e.g., an application store). Moreover, in one embodiment, the collection management platform 103 uses the at least one root collection object to specify the structure and content displayed in one or more content stores and/or in one or more applications highlighting one or more available content items (e.g., App Highlights by NOKIA). Then in step 411, the collection management platform 103 processes and/or facilitates a processing of the one or more collection objects to determine one or more sub-collection objects based, at least in part, on the at least one root collection object, wherein the presentation is further based, at least in part, on the one or more sub-collections. By way of example, the one or more sub-collection objects may also be based, at least in part, on the one or more parameters or milieu factors (e.g., location, device capability, language or keywords, authorship or operator, etc.). For example, the collection management platform 103 may determine that under the root collection object “game” there may be one or more sub-collection objects such as “soccer,” “football,” and “tennis” and under the sub-collection object “soccer” there may still be further sub-collection objects such as “soccer gear” and “soccer training”

In step 413, the collection management platform 103 determines at least one collection object hierarchy, at least one collection object layout, or a combination thereof based, at least in part, on the mapping, the at least one root collection object, or a combination thereof, wherein the presentation is further based, at least in part, on the at least one collection object hierarchy, the at least one collection object layout, or a combination thereof. In particular, the at least one collection object hierarchy enables the collection management platform 103 to manipulate the presentation or visibility of the one or more content items by determining that the at least one root collection object and the one or more sub-collection objects are each targeted for non-overlapping parameters or milieus so that a user only sees the one or more sub-collection objects visible in his or her milieu. Moreover, the at least one collection object hierarchy is also based, at least in part, on one or more dynamic criteria, one or more static criteria, or a combination thereof. Consequently, the at least one collection hierarchy can be dynamically built by the collection management platform 103 based, at least in part, on a sort order (e.g., “top rated”) or statically built to create locally relevant and/or temporary collections. In addition, the at least one collection object hierarchy containing the at least one root collection enables the collection management platform 103 to reuse one or more collection objects. For example, in the “soccer” example use case, the sub-collection object “soccer training” can be further mapped by the collection management platform 103 to at least one other root collection object (e.g., “training), which may contain the sub-collection objects “soccer training,” and “java training” Further, the at least one collection hierarchy may be locally or globally built by the collection management platform 103 (e.g., for only a content store in one location or for all content stores worldwide).

In one or more embodiments, the collection management platform 103 associates the one or more collection objects with at least one collection object layout, which determines the “look and feel” of one or more collections, one or more content stores, or a combination thereof. More specifically, in one embodiment, the collection management platform 103 determines the at least one collection object layout based, at least in part, one the one or more collection objects, the one or more sub-collection objects, or a combination thereof. Moreover, the collection management platform 103 includes or has access to a number of default layouts (e.g., 4×3, 2×n, 1×n, search, etc.) and enables a content store manager, for example, to add new layouts based, at least in part, a number of slots (e.g., “12”) and/or one or more rules (e.g., “backfill,” “defined rules,” etc.). In addition, the collection management platform 103 can reuse the at least one collection object layout. For example, the collection management platform 103 can associate one or more collection objects with the same at least one collection object layout. As a result, it is contemplated that global or local content store managers, for example, are able to change/configure a user interface layout at will from the back-end of the collection management platform 103 without requiring complicated code changes or expensive client upgrades, which is particularly relevant in different parts of the world where users generally prefer one layout design over another.

FIG. 5 depicts a process of presenting the one or more collection objects in one or more content stores (e.g., an application store). In one embodiment, the collection management platform 103 performs the process 500 and is implemented in, for instance, a chip set including a processor and a memory as shown in FIG. 9. In step 501, the collection management platform 103 causes, at least in part, a presentation of the one or more collection objects in one or more content stores, one or more content store management systems, or a combination thereof. By way of example, the presentation of the one or more collection objects in the one or more content stores may include, at least in part, a presentation of the one or more associated content items in at least one collection layout (e.g., default 4×3). In contrast, the presentation of the one or more collection objects in the content store management system may include, at least in part, a data table including a name, an id, a type, an updated date, a validity status, a last export date, a view status, an edit status, a clone status, a deletion status, and an author, for example. An illustrative example of a data table is depicted in FIG. 7. More specifically, in one embodiment, the content store management system is a single unified programming tool that is centralized, secure, and access-controlled by the collection management platform 103 to manage all of the one or more collection objects, including the one or more sub-collection objects associated with the one or more content stores (e.g., an application store). In particular, the content store management system enables the collection management platform 103 to manage users in the system, assign role-based access, and control access at an operational level. Moreover, the content store management system enables the collection management platform 103 to support one or more content stores with the same programming tool. Further, as previously discussed, it is contemplated that use of the same tool by personnel of different authorities and access privileges facilitates better collaboration among the personnel without inhibiting LSUs from operating independently in their own areas on their own content. Consequently, merchandizers are able to better share their experiences of what works and/or what does not work (e.g., if an LSU in a particular location created a collection object that was very successful, an LSU in another location can request to be added to that collection object or clone it for his or her location.

In step 503, the collection management platform 103 causes, at least in part, one or more modifications of at least one user interface element based, at least in part, the at least one collection object hierarchy, the at least one collection object layout, or a combination thereof. For example, in terms of structure, the at least one collection object layout mirrors the at least one collection object hierarchy and in terms of “look and feel,” the at least one user interface element or client page layout is determined by the at least one layout associated with one or more collection objects. In addition, the content of the at least one user interface element is also determined by one or more collection objects, one or more sub-collection objects, or a combination thereof (static or dynamic), which, in one embodiment, form the basis of the at least one collection object hierarchy. Therefore, if the collection management platform 103 causes, at least in part, a change to the at least one collection object hierarchy, the at least one collection object layout, or a combination thereof, then the at least one user interface element will also be changed by the collection management platform 103 accordingly. Moreover, it is contemplated that the collection management platform 103 can enable a pure configuration of a client user interface (i.e., no code changes are required for a server or the client). Consequently, changes are effective as soon as the one or more relevant caches clear, meaning faster turnaround for content store managers, for example, to view their respective changes.

In step 505, the collection management platform 103 optionally causes, at least in part, at least one update of the one or more collection objects, the one or more sub-collection objects, or a combination thereof based, at least in part, on one or more other content items, the one or more dynamic rules, or a combination thereof. By way of example, the one or more dynamic rules enable the collection management platform 103 to automatically surface and include one or more other content items (e.g., a new application, an update, etc.) that match the specified criteria of the one or more rules associated with the one or more collection objects. As a result, the collection management platform 103 implicitly ensures one or more “fresh” content items within a content store. More specifically, the collection management platform 103 can assign each one or more new collection objects a new generation id so when the one or more collection objects is exported by the content store management system, for example, clients can get incremental updates of the one or more collection objects. In addition, the one or more updates may also include a deactivation of the one or more collection objects by the collection management platform 103 so that the one or more collections are no longer automatically picked up by the content store management system, for example, to be exported to the one or more content stores.

In step 507, the collection management platform 103 optionally determines one or more blacklists of content, one or more whitelists of content, or a combination thereof associated with the one or content items, the one or more collection objects, the one or more sub-collection objects, or a combination thereof. In particular, the collection management platform 103 enables content store managers, for example, to specify one or more content items for specific product promotions (e.g., whitelists) or to prohibit one or more content items from being associated with one or more collection objects corresponding to one or more content stores (e.g., blacklists). By way of example, a blacklist collection is a specific collection that defines content to be removed from some or all parts of a content store either because the underlying content item is utterly offensive (i.e., blacklisted globally) or because the content item is offensive in certain regions/countries or the nomenclature is offensive in some languages/cultures (i.e., targeted blacklisting). The collection management platform 103 can also determine to blacklist one or more content items that may be inconvenient on some devices either due to size or resource requirement (e.g., if the content item's file size is large and generally fails to download in a limited bandwidth operator network or if the content item requires considerable memory/processing capabilities to ensure a satisfactory user experience). Moreover, the collection management platform 103 can determine to blacklist content in favor of a similar branded content item that is being promoted during a particular time period or for the foreseeable future.

In step 509, the collection management platform 103 processes and/or facilitates a processing of the one or more blacklists, the one or more whitelists, or a combination thereof to modify the at least one collection object hierarchy, the at least one collection object layout, or a combination thereof, wherein the one or more blacklists, the one or more whitelists, or a combination thereof are based, at least in part, on the one or more parameters. In particular, while the one or more blacklisted content items may still appear in the content store management system, for example, the collection management platform 103 prevents such content from being presented or viewed in the one or more relevant content stores. In contrast to blacklisted content, the collection management platform 103 can promote one or more content items designated by the collection management platform 103 for whitelisting by mapping the one or more content items to one or more prominent collection objects (e.g., the Features Collection, the Banner and Spotlight Collection, etc.). By way of further example, the collection management platform 103 can also determine to blacklist content by location within the one or more content stores (e.g., preventing the one or more content items, the one or more collection objects, or a combination thereof from appearing on the home page of a content store); by publisher or rule (e.g., if one or more publishers are identified as rogue users that “spam” the collection management platform 103 with one or more substandard content items); and by a time bound promotion (e.g., if a merchandizer wants to promote a relatively new content item in direct competition with an existing popular content item).

In step 511, the collection management platform 103 optionally determines the one or more collection objects, the one or more sub-collection objects, or a combination thereof based, at least in part, on at least one faceted search. By way of example, a faceted search enables the collection management platform 103 to identify static content for one or more existing collection objects and/or define one or more dynamic rules for one or more collection objects. More specifically, a content store manager, for example, may define the one or more parameters (or facets) of the one or more dynamic rules (e.g., a category, a publisher, a price point, etc.), which may help refine one or more searches of the one or more content items, the one or more collection objects, or a combination thereof associated with one or more content stores.

FIG. 6 is a diagram of a user interface utilized in the process of FIG. 4 for defining one or more dynamic rules, according to one embodiment. As shown, the example user interface of FIG. 6 includes one or more interface elements and/or functionalities created and/or modified based, at least in part, on information, data, and/or signals resulting from the processes (e.g., process 400) described with respect to FIG. 4. More specifically, FIG. 6 illustrates a tabbed interface (e.g., interface 601) of a content store management system, wherein the “rules” tab 603 has been activated by a content store manager, for example, to specify one or more dynamic rules to be associated with one or more content items (e.g., an application), one or more collection objects, or a combination thereof by the system 100 based, at least in part, on one or more parameters as further illustrated by the active “add” tab 605. In particular, the interface 601 enables the content store manager to specify one or more dynamic rules using a faceted search (e.g., under the “add using fs” tab 607). In addition, the interface 601 enables the content store manager to specify one or more saved rules by activating the “view all” tab 609 or by inputting a name/description or id or one or more keywords in the data entry boxes “name” 611 or “keywords” 613, respectively. Moreover, the interface 601 enables the content store manager to determine the one or more dynamic rules based on one or more parameters (e.g., “categories” 615, “publisher” 617, “price” 619, “items sort order” 621, etc.). Further, as previously discussed, the interface 601 also includes one or more preview functionalities available under the “preview” tab 623. In particular, the content store manager can preview the one or more parameters set for a rule (e.g., a category, a publisher, etc.), view the one or more collection objects that will refer that rule, and preview the top 30 items, for example, that will surface accordingly.

FIG. 7 is a diagram of a user interface utilized in the processes of FIGS. 4 and 5 for organizing one or more collection objects in one or more content stores, according to one embodiment. As shown, the example user interface of FIG. 7 includes one or more interface elements and/or functionalities created and/or modified based, at least in part, on information, data, and/or signals resulting from the processes (e.g., processes 400 and 500) described with respect to FIGS. 4 and 5. More specifically, FIG. 7 illustrates a tabbed interface (e.g., interface 701) of a content store management system, wherein the “collections” tab 703 has been activated by a content store manager, for example, to review one or more collection objects associated with one or more content stores and/or one or more applications highlighting one or more available content items (e.g., App Highlights by NOKIA). In particular, in one or more embodiments, once the system 100 determines the at least one collection hierarchy, the at least one collection layout, or a combination thereof, the system 100 causes, at least in part, a presentation of the one or more collection objects in one or more content stores, a content store management system (e.g., interface 701), or a combination thereof. In particular, the one or more collection objects may be determined by entering one or more credentials in the “login/log out” box 705 and then entering a name/description or id associated with one or more collection objects in the “search by name or id” data entry box 707. Based on the entered criteria, the system 100 can cause, at least in part, a presentation of the one or more corresponding collection objects in the table 709 including a name, an id, a type, an updated date, a validity status, a last export date, a view status, an edit status, a clone status, a deletion status, an author, for example.

In one embodiment, once the system 100 causes, at least in part, a presentation of the one or more relevant collection objects in the interface 701, for example, the content store manager can preview the one or more collection objects under the “preview” tab 711 to get a sense of content availability in a user's milieu. Moreover, the interface 701 enables the content store manager to sort the one or more content items or the one or more collection objects under the “sort” tab 713. In addition, the interface 701 enables the content store manager to associate the one or more collection objects with at least one collection object layout under the “layouts” tab 715, which defines the “look and feel” of the one or more collection items (e.g., an application), the one or more collection objects (e.g., “games”), or a combination thereof. Further, the interface 701 enables the content store manager to obtain various reports under the “reports” tab 717, which enables the content store manager, for example, to monitor the system 100 and provisioning tasks, keep audit logs on user activity, view collection distribution by targeting dimensions, compare download data to monitor collection campaign effectiveness, etc. Also, as previously discussed, the one or more content catalogs are imported into the system 100 under the “import” tab 719 and one or more collection objects are exported out of the content store management system under the “export” tab 721.

The processes described herein for mapping relevant and up-to-date online content to content collections using a single programming tool may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to map relevant and up-to-date online content to content collections using a single programming tool as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of mapping relevant and up-to-date online content to content collections using a single programming tool.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to map relevant and up-to-date online content to content collections using a single programming tool. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for mapping relevant and up-to-date online content to content collections using a single programming tool. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for mapping relevant and up-to-date online content to content collections using a single programming tool, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for mapping relevant and up-to-date online content to content collections using a single programming tool to the UEs 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to map relevant and up-to-date online content to content collections using a single programming tool as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of mapping relevant and up-to-date online content to content collections using a single programming tool.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to map relevant and up-to-date online content to content collections using a single programming tool. The memory 905 also stores the data associated with or generated by the execution of the inventive steps.

FIG. 10 is a diagram of exemplary components of a mobile device (e.g., mobile terminal, mobile phone, handset, etc.) for communications, which is capable of operating in the system of FIG. 1, according to one embodiment. In some embodiments, mobile terminal 1001, or a portion thereof, constitutes a means for performing one or more steps of mapping relevant and up-to-date online content to content collections using a single programming tool. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of mapping relevant and up-to-date online content to content collections using a single programming tool. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to map relevant and up-to-date online content to content collections using a single programming tool. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of one or more content items from one or more content catalogs;
a mapping of the one or more content items to one or more collection objects; and
a presentation of the one or more collection objects in one or more content stores, one or more content store management systems, or a combination thereof.

2. A method of claim 1, wherein the (1) data and/or (2) information and/or (3) at least one signal are further based, at least in part, on the following:
at least one determination of one or more static rules, one or more dynamic rules, or a combination thereof associated with the one or more content items, the one or more collection objects, or a combination thereof based, at least in part, on one or more parameters; and
a generation of the one or more collection objects based, at least in part, on the one or more static rules, the one or more dynamic rules, or a combination thereof.

3. A method of claim 2, wherein the one or more parameters are based, at least in part, on location, device capabilities, language or keywords, authorship or operators, or a combination thereof.

4. A method of claim 1, wherein the (1) data and/or (2) information and/or (3) at least one signal are further based, at least in part, on the following:
at least one determination of at least one root collection object among the one or more collection objects based, at least in part, on the one or more parameters; and
a processing of the one or more collection objects to determine one or more sub-collection objects based, at least in part, on the at least one root collection object,
wherein the presentation is further based, at least in part, on the one or more sub-collections.

5. A method of claim 4, wherein the (1) data and/or (2) information and/or (3) at least one signal are further based, at least in part, on the following:
at least one determination of the one or more collection objects, the one or more sub-collection objects, or a combination thereof based, at least in part, on at least one faceted search.

6. A method of claim 1, wherein the (1) data and/or (2) information and/or (3) at least one signal are further based, at least in part, on the following:
at least one determination of at least one collection object hierarchy, at least one collection object layout, or a combination thereof based, at least in part, on the mapping, the at least one root collection object, or a combination thereof,
wherein the presentation is further based, at least in part, on the at least one collection object hierarchy, the at least one collection object layout, or a combination thereof.

7. A method of claim 6, wherein the (1) data and/or (2) information and/or (3) at least one signal are further based, at least in part, on the following:
one or more modifications of at least one user interface element based, at least in part, the at least one collection object hierarchy, the at least one collection object layout, or a combination thereof.

8. A method of claim 6, wherein the collection object hierarchy is based, at least in part, on one or more dynamic criteria, one or more static criteria, or a combination thereof.

9. A method of claim 1, wherein the (1) data and/or (2) information and/or (3) at least one signal are further based, at least in part, on the following:
at least one update of the one or more collection objects, the one or more sub-collection objects, or a combination thereof based, at least in part, on one or more other content items, the one or more dynamic rules, or a combination thereof.

10. A method of claim 1, wherein the (1) data and/or (2) information and/or (3) at least one signal are further based, at least in part, on the following:
at least one determination of one or more blacklists of content, one or more whitelists of content, or a combination thereof associated with the one or content items, the one or more collection objects, the one or more sub-collection objects, or a combination thereof; and
a processing of the one or more blacklists, the one or more whitelists, or a combination thereof to modify the at least one collection object hierarchy, the at least one collection object layout, or a combination thereof,
wherein the one or more blacklists, the one or more whitelists, or a combination thereof are based, at least in part, on the one or more parameters.

11. An apparatus comprising:
at least one processor; and
at least one memory including computer program code for one or more programs,
the at least one memory and the computer program code configured to, with the at least one processor, cause the apparatus to perform at least the following,
determine one or more content items from one or more content catalogs;
cause, at least in part, a mapping of the one or more content items to one or more collection objects; and
cause, at least in part, a presentation of the one or more collection objects in one or more content stores, one or more content store management systems, or a combination thereof.

12. An apparatus of claim 11, wherein the apparatus is further caused to:
determine one or more static rules, one or more dynamic rules, or a combination thereof associated with the one or more content items, the one or more collection objects, or a combination thereof based, at least in part, on one or more parameters; and
cause, at least in part, a generation of the one or more collection objects based, at least in part, on the one or more static rules, the one or more dynamic rules, or a combination thereof.

13. An apparatus of claim 12, wherein the one or more parameters are based, at least in part, on location, device capabilities, language or keywords, authorship or operators, or a combination thereof.

14. An apparatus of claim 11, wherein the apparatus is further caused to:
determine at least one root collection object among the one or more collection objects based, at least in part, on the one or more parameters; and
process and/or facilitate a processing of the one or more collection objects to determine one or more sub-collection objects based, at least in part, on the at least one root collection object,
wherein the presentation is further based, at least in part, on the one or more sub-collections.

15. An apparatus of claim 14, wherein the apparatus is further caused to:
determine the one or more collection objects, the one or more sub-collection objects, or a combination thereof based, at least in part, on at least one faceted search.

16. An apparatus of claim 11, wherein the apparatus is further caused to:
determine at least one collection object hierarchy, at least one collection object layout, or a combination thereof based, at least in part, on the mapping, the at least one root collection object, or a combination thereof,
wherein the presentation is further based, at least in part, on the at least one collection object hierarchy, the at least one collection object layout, or a combination thereof.

17. An apparatus of claim 16, wherein the apparatus is further caused to:
cause, at least in part, one or more modifications of at least one user interface element based, at least in part, the at least one collection object hierarchy, the at least one collection object layout, or a combination thereof.

18. An apparatus of claim 16, wherein the collection object hierarchy is based, at least in part, on one or more dynamic criteria, one or more static criteria, or a combination thereof.

19. An apparatus of claim 11, wherein the apparatus is further caused to:
cause, at least in part, at least one update of the one or more collection objects, the one or more sub-collection objects, or a combination thereof based, at least in part, on one or more other content items, the one or more dynamic rules, or a combination thereof.

20. An apparatus of claim 11, wherein the apparatus is further caused to:
determine one or more blacklists of content, one or more whitelists of content, or a combination thereof associated with the one or content items, the one or more collection objects, the one or more sub-collection objects, or a combination thereof; and
process and/or facilitate a processing of the one or more blacklists, the one or more whitelists, or a combination thereof to modify the at least one collection object hierarchy, the at least one collection object layout, or a combination thereof,
wherein the one or more blacklists, the one or more whitelists, or a combination thereof are based, at least in part, on the one or more parameters.

21.-48. (canceled)
